(19) United States
(12) Patent Application Publication
(10) Pub. No.: US 2003/0144794 A1
(43) Pub. Date: Jul. 31, 2003

(54) System for the destination routing of vehicles

(76) Inventor: Robert Schuessler, Stuttgart (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/339,672

(22) Filed: Jan. 10, 2003

(30) Foreign Application Priority Data
Jan. 10, 2002 (DE) 102 00 758.6

(51) Int. Cl. G01C 21/34

(52) U.S. Cl. 701/210; 701/209; 340/990

(57) ABSTRACT

A method for dynamic destination routing of a vehicle includes the steps of a) determining several routes between a starting point and a destination point; b) determining additional information relevant to the computed routes from additional information which is received from an external transmitting unit and/or is stored in a memory carried along in the vehicle; c) determining the route which is optimal when the additional information is taken into account from the computed routes; and d) outputting destination routing information concerning the optimal route. A system for the destination routing of a vehicle comprises a system part fixedly installed on the vehicle and a portable system part. The system part fixedly installed in the vehicle is connected with the portable system part by way of at least one communication interface. A static destination routing is implemented on the system part fixedly installed in the vehicle and the dynamic processing of the static destination routing is implemented on the portable system part.

### CROSS-REFERENCE TO RELATED APPLICATIONS

This application is related to U.S. application Ser. No. ______ filed on Jan. 10, 2003.

### BACKGROUND AND SUMMARY OF THE INVENTION

This application claims the priority of German patent document 102 00 758.6, filed Jan. 10, 2002, the disclosure of which is expressly incorporated by reference herein.

The invention relates to a system for the dynamic destination routing of vehicles.

European Patent Document EP 0 838 797 A1 discloses a destination routing system for a vehicle, in which a first (static) route is computed without considering traffic information. The destination routing is then started for the first route and, during the drive, received traffic information is analyzed with respect to its relevance to the first route. If relevant traffic information occurs for the first route, a second (dynamic) route is computed, considering traffic information. The second route is offered for selection to the driver as an alternative route, if the computed driving time is shorter on the alternative route than on the first route. Selection of the alternative route is performed by driving the alternative route.

German Patent Document DE 199 56 108 A1 discloses a method for dynamic destination routing of a motor vehicle, in which, when traffic hindrances occur on an originally computed route, alternative routes are computed for several turn-off points, bypassing the traffic hindrance. The alternative routes are offered to the driver for his selection. The driver may choose an alternative route by way of an operating unit. As an alternative, the driver can select the alternative route by driving it, in which case the system automatically recognizes which of the suggested routes is driven by the driver. The driver then receives destination routing information with respect to the ,recognized alternative route.

International Patent Document WO 00/74019 A1 discloses a vehicle borne destination routing system which is utilized in connection with a portable terminal, such as a PDA (Personal Digital Assistant) or a mobile radio communications unit. The portable terminal is used for loading data into the destination routing system of the vehicle. These data are destination inputs of the driver, route inputs of the driver, card data or new software statuses. The data connection between the portable terminal and the destination routing system in the vehicle may be either wireless or wire-bound manner.

One object of the invention to provide a system for dynamic destination routing of vehicles of the initially mentioned type, which permits a simple separation of the actual destination routing and the dynamic processing of the destination rooting.

This and other objects and advantages are achieved by the destination routing system according to the invention, in which several routes between the actual location and the destination location are computed from a defined destination location and a defined starting location, for example, the actual location of the vehicle, in Step a) of the process. This computation takes place on the basis of information stored in a digital map on board the vehicle, without taking into account dynamic additional information, such as the traffic information. Different criteria can be used as a basis to determine the static routes, such as the shortest route, the fastest route, no distances subject to tolls, no turnpike, etc. In addition to a thus determined optimal route, a number of additional routes are determined. This set of routes, consisting of several routes, forms the basis of the subsequent Step b) of the process.

In Step b), additional information received from outside the vehicle and/or additional information stored in a memory on board in the vehicle are analyzed as to whether they are relevant to the set of routes determined in Step a) . With respect to traffic information, for example, it is checked whether a traffic hindrance exists on one of the routes which is a component of the set of routes. The additional information received from the outside comprises RDS (Radio Data System) data and/or RDS/TMC (Radio Data System/Traffic Message Channel) data, and/or data of information services, for example, on the GSM basis, and or data from Internet-based and/or WAP-(Wireless Application Protocol) based services. The additional information, which is stored in the memory on board the vehicle, comprises, for example, construction site information, traffic flow lines, predicted traffic information, etc. The memory on board the vehicle may be, for example, a component of a portable terminal which can be connected in data communication with the vehicle. The driver can remove the portable terminal from the vehicle and,connect it, for example, at home with his PC in order to download up-to-date information there from the Internet concerning, for example, construction sites, and/or information concerning the region to be approached by him. It is also possible to made predictions from the received additional information, for example, concerning the development of traffic hindrances and to file these predictions in the memory carried along in the vehicle.

In Step c), a route is determined from the set of routes, which is optimal when the additional information is taken into account. When traffic information is available, for example, the travel time for all routes of the set of routes is determined and the optimal dynamic route (for example, the fastest route) is selected as the optimal route. The latter will then be used as the basis for Step d), in which the route information is optically and/or acoustically emitted to the driver.

Such a method for the dynamic destination routing is particularly advantageous because it permits a functional separation of the static destination routing and dynamic processing of destination routing.

This allows an advantageous division between functions of static process steps, which are implemented on system parts fixedly installed in the vehicle, and functions of other process steps which relate to the dynamic processing of the routing. The latter includes processes and options (particularly with respect to the offered traffic data and their utilization) that are subjected to a constant change. For example, information sources may have a short life compared with the service life of a vehicle and may apply only to certain regions or to certain traffic route networks. The static process steps, on the other hand, remain constant for a fairly long run time. As a result of the functional separation of the process steps which evolve at different speeds, it is therefore possible to service these separately, replace them separately by new versions, enhance them separately by means of new subfunctions, etc.

The process analyzes additional information, particularly traffic information, from several information sources and mutually matches this information. These information sources comprise RDS, RDS/TMS, control-station-supported services, internet-based and/or WAP-based services. In this manner, dynamic processing of the destination routing can be carried out on the basis of a plurality of data, which increases the currency and the reliability of the process. As a result of matching, it can also be ensured that all additional information output to the driver is free of contradictions.

During the drive, it is constantly checked whether the routing makes sense (that is, whether it remains optimal). For this purpose, the destination routing carries out a type of self-diagnosis in order to determine whether the recommendations previously made continue to make sense in the context of the actual situation. Based on the results of such self diagnosis, it is advantageous to supply explanatory information to the driver to increase his or her acceptance.

To check whether the routing makes sense, a comparison is made for example, to judge whether the actual parameters correspond to the parameters determined and used during the determination of the optimal route in Step c). In an advantageous embodiment of the invention a continuous comparison is made during the drive to determine whether the actual driving progress (for example, the actually driven path and/or the time which has passed since the start of the drive) corresponds to the driving progress computed in determining the optimal route in Step c). This constant comparison ensures that the information offered to the driver by the destination routing system does not contradict his or her direct on-site perception. This is especially relevant when using predicted additional information, particularly traffic information. When a predicted traffic event does not occur, it is possible to determine this fact by comparison of the actual driving progress and the assumed driving progress.

When the actual parameters deviate from the determined parameters of the optimal route, action can be taken to increase the quality of the destination routing and/or to increase the acceptance by the driver. For example, other, more detailed additional information can be requested which may help to clarify the deviation or to implement new measures. For example, explanatory information can be supplied to the driver which explains the deviation and informs him that a search is taking place for an alternative route.

To judge whether the route recommendation makes sense, it is also advantageous to take into account that different sources may exist for the additional information. The sources for additional information, which are simultaneously available may differ with respect to the quality of the information (for example, its correctness, currency or quantity, or its completeness and/or depth of detail). The method takes these differences into account during the analysis and the matching. It is also advantageous to supply explanatory information to the driver which comprises, for example, the source of the additional information taken into account in the destination routing with an assessment of its qualitative and/or quantitative characteristics. Such explanatory information enables the driver to understand the situation and the information on which the destination routing information is based. In the event of apparent mistakes of the destination routing, this increases the acceptance by the driver.

In an advantageous further development of the invention, during the drive it is evaluated whether the route recommendation makes sense by checking whether relevant additional information is available and/or is arriving for the residual route which remains to be driven. Such additional information may include externally received additional information and/or information present in a memory on board in the vehicle. The details of the additional information are constantly verified. Thus, during the drive, new additional information may actively be requested, for example, when a local traffic jam is approached (specifically detailed and updated additional information concerning the traffic jam located ahead of the vehicle), so that a precise reaction can take place by means of the existing updated and detailed additional information.

If new aspects occur during the drive, for example, in that the real parameters deviate from the determined parameters of the optimal route and/or that the additional information concerning the route ahead of the vehicle changes, a dynamic computation of the residual route is triggered, that is, of the route from the current location of the vehicle to the destination.

The dynamic computation of the residual route advantageously takes place by means of the following process. In Step aa), several static residual routes are computed between the current location and the destination location. Additional information is determined in Step bb) which is relevant to this set of residual routes consisting of the several static residual routes, and taking into account such relevant additional information, an optimal residual route is determined in Step cc). Destination routing instructions concerning this residual route are issued to the driver in Step dd). The process takes place analogous to the process with Steps a) to d), but relates to a residual route to the destination during the drive.

Further, the acceptance by the driver can be increased if for example, when he or she is caught in a traffic jam, an explanation is provided why, for example, no alternative route was selected. As a result, it is possible for the driver to eliminate apparent contradictions between the actions of the destination routing and his own additional information obtained, for example, from his direct perception of the local traffic situation.

The destination routing system comprises two system parts. The first system part is fixedly installed in the vehicle and comprises a computer, a memory, particularly for storing a digital map, an input unit and an output unit. The second system part is constructed to be portable and comprises a memory, particularly for storing additional information; a computer; a receiving unit, particularly for receiving additional information; and a computer. The second system part may be constructed as a PDA, a PDA-type unit, a laptop, or a portable mobile phone. It may also be constructed as a unit so that one or more units are integrated in a housing or several units can be fitted together.

The static destination routing, which is based on the data stored in the digital map, is performed on the system part fixedly installed in the vehicle. The static destination routing takes into account no dynamic additional information. The dynamic processing of the destination routing is carried out on the portable system part, where the dynamic additional information is taken into account.

This arrangement permits a novel division of functions between static process steps, which take place on system parts fixedly installed in the vehicle, and process steps with respect to the dynamic processing which take place on portable system parts which can be connected with the vehicle. The latter can be easily exchanged; they can also be pre-recorded with new software versions; and can therefore easily be changed, even after delivery of the vehicle. This is advantageous for the implementation of processes and options in the dynamic processing the destination routing which (particularly with respect to the offered traffic data and their utilization) are subjected to constant changes. The functional division according to the invention into system parts installed in the vehicle and portable system parts simplifies further development of the dynamic functionalities, with lower expenditures.

The allocation of the static and dynamic process steps to the first and the second system parts in the vehicle is such that Steps a) and d), or aa) and dd) of the destination routing process are implemented on the first system part which is installed in the vehicle. Steps b) and c), or bb) and cc) of the destination routing process are implemented on the second, portable system part.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic block diagram of a vehicle destination routing system according to the invention;

FIG. 2 is a flow chart which illustrates a destination routing process;

FIG. 3 is a flow chart which illustrates a destination routing process for a residual route.

### DETAILED DESCRIPTION OF THE DRAWINGS

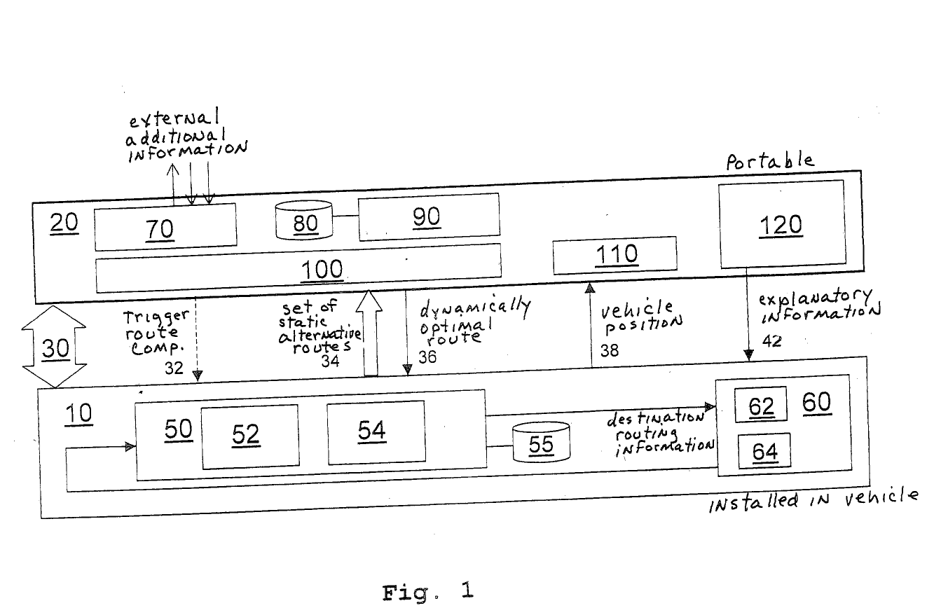

FIG. 1 is a schematic representation of a vehicle destination routing system with a first system part 10 fixedly installed in the vehicle and a portable second system part 20 with a wireless or wire-bound data connection 30. The driver or user can establish the data connection, for example, by plugging the portable system part 20 into a receiving device. The receiving device then establishes the data-related connection with the first system part 10, whether it is wire-bound or wireless. The wireless data connection can be implemented, for example, by way of infrared and/or radio, such as Bluetooth. For this purpose, the corresponding interface, such as Bluetooth, may also be integrated directly in the portable system part.

As illustrated in FIG. 1, the first system part 10 may be accommodated in a housing. However, it is also possible to accommodate the modules 50, 52, 54, 55, 60, 62, 64 of the system part 10 in various housings and connect them, for example, by means of a data bus system.

Data which are exchanged by way of the data connection 30 between the system part 10 fixedly installed in the vehicle and the portable system part 20 may comprise, for example, the information indicated in FIG. 1, such as the trigger for a new route computation 32, the set of “static” alternative routes 34, the “dynamically’ optimal route 36, the vehicle position 38 and/or the explanatory information for the driver 42.

The system part 10 fixedly installed in the vehicle comprises the navigation module 50, the memory 55, particularly for a digital map, and the display and operating unit 60. The navigation module 50 comprises the route computation 52 and generates the destination routing information 54. The figure does not separately show the unit which determines the vehicle position 38, for example, by means of satellite locating, such as the GPS. As an alternative or in addition, vehicle sensor data, such as rotating rate sensor data, rotational wheel speed sensor data, can be analyzed. Additional locating possibilities consist of the analysis of mobile radio communication cells and/or radio locating and/or beacons. The unit for determining the position is advantageously situated in the system part 10 because vehicle sensors can easily be analyzed in the vehicle. However, it is also possible to perform the position determination in the system part 20, which is advantageous, for example, for the mobile radio communication cell analysis or when the system part 20 contains the GPS.

The display and operating unit 60 comprises an output unit 62 and an input unit 64. The output unit 62 may be constructed as an optical and/or acoustic output unit, and is used, for example, to output destination routing information. The input unit 64 is used, for example, for input of the destination. As an alternative, the system offers the possibility of automatically recognizing a destination when the driver moves along a route which is frequently driven by him.

The portable system part 20 comprises a memory 80, particularly for stored “off-line” traffic data/information, with an associated analyzing unit 90, a transmitting/receiving device with an analyzing unit 70 for additional information available “on-line”, which is received either by way of a broadcasting channel or is received and/or requested by way of a bi-directional channel and is then received. The portable system part 20 also includes a unit 100 for determining the optimal route from the set of static alternative routes 34. The unit 110 monitors real parameters and compares them with parameters assumed when determining the optimal route. For determining the real driving progress, the unit 110 receives the vehicle position 38 from the system part 10 by way of the data connection 30. A digital map may also be stored in the memory 80, which map is sufficiently detailed to permit the unit 110 to image the driving progress and the additional information on the digital map. The unit 120 generates explanatory information 42, which is transmitted to the system part 10 by way of the connection 30 and emitted by the output unit 62.

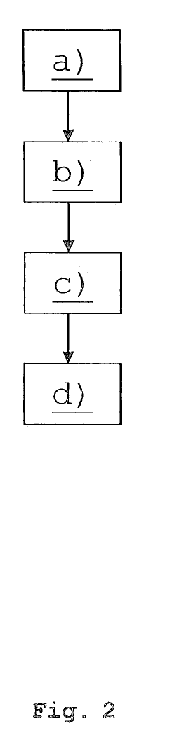

FIG. 2 illustrates the destination routing method as an example. The destination routing operation is started for example, when the driver or user inputs a destination into the input unit 64, and/or when the navigation module 50 recognizes a route frequently used by the driver as well as its destination. A position determination device (not shown) determines the actual position of the vehicle. Then, in Step a), which is advantageously implemented in the system part 10 on the navigation module 50 (in particular, the route computation unit 52), a set of routes 34 is computed between the actual position, which corresponds to the starting point, and the destination point, taking into account the digital map stored in the memory 55. The memory 55 is constructed, for example, as a mass memory in the form of a CD or DVD.

The set of routes 34 computed in the route computation unit 52 is forwarded to the system part 20 via the data connection 30. In Step b), relevant additional information for the set 34 of routes is determined in units 70 and 90. The route 36 which is optimal with respect to an applicable criterion and the additional information is determined in Step c) in unit 100 of the system part 20, based on the additional information relevant for the set 34 of routes determined in units 70 and 90. The time required to drive the route is advantageously selected as the criterion. However, other criteria, such as the lowest toll, are also possible.

The dynamically optimal route 38 is then forwarded by way of the data connection 30 to the system part 10, where destination routing information is generated in the module 54 with respect to the route 38 and is forwarded to the module 62 for the output.

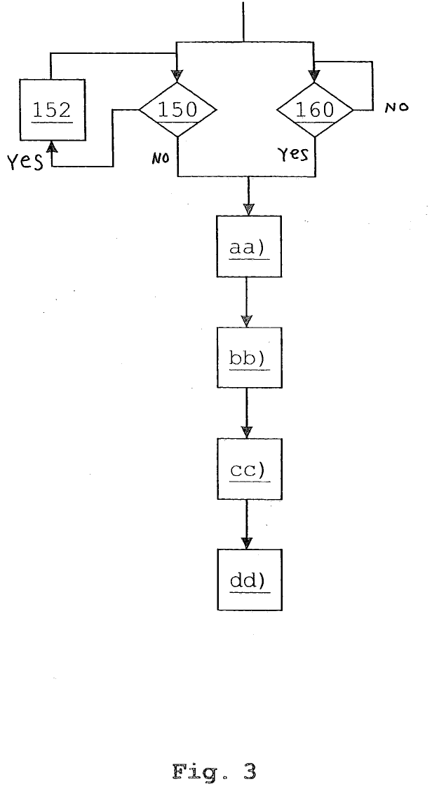

FIG. 3 is a flow chart that illustrates an example of the flow of the determination of a dynamically optimal residual route during the drive. In Step 150 an inquiry is made whether the actual driving progress corresponds to the driving progress used as the basis for computing the optimal route in Step c). If not (“no” branch), the route computation 32 trigger is set. In addition, it is advantageous in this situation to optionally, in Step 152, supply explanatory information 42 to the driver, explaining that contrary to expectations, the drive will take place in a manner that is different than planned, and that the system is working on the problem. This increases the acceptance of the system, because the driver will not feel abandoned in the event of a contradiction between reality and assumptions of the system.

During the drive, it is determined in Step 160 whether new additional information is present, for example having been received spontaneously or queried concretely from the system part 20. It is advantageous to initiate the query, for example, when the vehicle approaches a predicted traffic jam in order to thus query in a targeted manner detailed and locally limited additional information. It also makes sense to initiate a query when it is determined in Step 150 that real parameters do not correspond to assumed parameters, in order to determine the cause of the discrepancy by way of requested detailed information and, if required, to be able to supply the driver with explanatory information 42.

If real parameters and assumed parameters do not correspond to one another (“no” branch in Step 150), or if new additional information is present (“yes” branch in Step 160), the trigger 32 is set again, and the computation of a set of residual routes by the module 52 is triggered in step aa) . The set of residual routes includes those (multiple) routes which lead from the current location of the vehicle to the destination location. Then, analogous to the set 34 of routes, the module 52 forwards the set of residual routes to the system part 20, where the relevant additional information for this set of residual routes is determined in Step bb). The optimal residual route is then determined (Step cc)) in module 100 taking into account the dynamic relevant additional information, analogous to the optimal route 36.

At this point, the optimal residual route can be forwarded to the system part 10. A check will then take place in the system part 10 as to whether the optimal residual route corresponds to the previous planned route. However, the latter determination may also be made in system part 20, in which case, a new route is forwarded to the system part 10 only if the determined dynamic optimal residual route differs from the optimal route 36.

If the optimal residual route corresponds to the previous planned route, destination routing instructions concerning the previous route continue to be emitted. In this case, Step dd) corresponds to the continuation of the output of destination routing instructions of Step d). In such a case, it is advantageous also to supply explanatory contradiction-free information 42 to the driver, in order to increase the acceptance when he is nevertheless in a traffic jam on the recommended route which was determined to be optimal. An example of such an explanatory information could be an indication that alternative routes had been checked but would demand even more driving time.

If the optimal residual route does not correspond to the previous planned route, destination routing instructions with respect to the optimal residual route are supplied in Step dd).

It is another advantage of the destination routing system that it can also be operated completely without the portable system part, using the basic function of a static destination routing. When the portable part has been forgotten or lost, destination routing can at least take place without any dynamic additional information.

It is also advantageous that the interactions of the system parts 10 and 20 take place unnoticed by the driver in the background, and permit a continuous adaptation of the destination routing to changing traffic situations.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A system for destination routing of a vehicle comprising:
a system part mounted on board the vehicle; and
a portable system part; wherein
the system part mounted on board the vehicle is connectable with the portable system part via at least one communication interface;
a static destination routing is implemented on the system part fixedly installed in the vehicle; and
dynamic processing of the static destination routing is implemented on the portable system part.

2. The system according to claim 1, wherein:
said destination routing includes the steps of
a) a determination of several routes between a starting point and a destination point;
b) a determination of additional information relevant to the computed routes from additional information received from an external transmitting unit and/or stored in a memory on board the vehicle;
c) a determination of a route from among the selected routes, which is optimal when the additional information is taken into account; and
d) an output of destination routing information concerning the optimal route;
at least the Steps a) and d) are performed by the system part on board the vehicle; and
at least the steps b) and c) are performed by the portable system part.

3. The system according to claim 2, wherein the route with the shortest travelling time is determined as optimal.

4. The system according to claim 2, wherein the additional information comprises traffic information.

5. The system according to claim 2, wherein the additional information is obtained from several different sources.

6. The system according to claim 2, wherein a check of whether the route recommendation remains optimal is carried out during the drive.

7. The system according to claim 6, wherein:
the check of whether the route recommendation remains optimal comprises a comparison of whether the actual operation parameters of the vehicle correspond to parameters used in determining the optimal route; and
the parameters include at least one of actual traveling time and actually covered distance.

8. The system according to claim 6, wherein the check of whether the route recommendation remains optimal comprises an evaluation of at least one of quality and quantity of the additional information.

9. The system according to claim 6, wherein the check of whether the route recommendation remains optimal takes into account that, during the drive, additional information relevant to a residual route to be driven is determined from additional information that is received from an external transmitting unit or is stored in a vehicle-internal memory.

10. The system according to claim 6, wherein as a result of checking whether the route recommendation remains optimal, a determination of a residual route is triggered, taking into account relevant additional information.

11. The system according to claim 10, wherein the portable system part includes means for determination of the residual route taking into account relevant additional information, including means for
aa) determining several residual routes between the current location and the destination point;
bb) determining additional information relevant to the computed residual routes from additional information which is received from an external transmitting unit or is stored in a vehicle-internal memory;
cc) determining a residual route which is optimal when the additional information is taken into account, from the computed residual routes; and
dd) outputting destination routing information concerning the optimal residual route.

12. The system according to claim 11, wherein:
at least aa) and dd) take place on the system part fixedly installed in the vehicle; and
at least bb) and cc) take place on the portable system part.

13. The system according to claim 2, wherein explanatory information is issued to the driver to increase acceptance of operation of said system.

14. The system according to claims 1, wherein the portable system part comprises a mobile communication device.
